(19) United States
(12) Patent Application Publication
(10) Pub. No.: US 2007/0286311 A1
(43) Pub. Date: Dec. 13, 2007

(54) Communications system comprising channelized receiver

(76) Inventors: Paul T. Coyne, Endicott, NY (US); Michael C. Dapp, Endwell, NY (US)

Correspondence Address: Lockheed Martin Corporation;c/o WOLF, GREENFIELD & SACKS, P.C., 600 ATLANTIC AVENUE, BOSTON, MA, 02210-2206, US

(21) Appl. No.: 11/799,316

(22) Filed: May 1, 2007

Related U.S. Application Data
(60) Provisional application No. 60/796,464, filed on May 1, 2006.

(51) Int. Cl. H04L 27/06

(52) U.S. Cl. 375/340

(57) ABSTRACT

A communications system comprising a channelized receiver is provided. In some embodiments, the system extends the capabilities of the channelized receiver, enabling the system to perform electronic surveillance monitoring (ESM) or relay functions. As such, the system may be employed to receive, process and provide information to downstream devices. In some embodiments, the system provides wideband communications capability. The system may also include a programmable demodulator for extracting communications data from incoming signals.

### RELATED APPLICATIONS

This application claims the benefit under 35 U.S.C. § 119(e) of U.S. Provisional Patent Application No. 60/796,464, filed May 1, 2006, the entire contents of which are incorporated herein by reference.

### FIELD OF INVENTION

Aspects of this invention relate generally to communication systems, and more particularly to digital signal processing.

### DISCUSSION OF RELATED ART

Signal detection systems for scanning a wide range of electromagnetic frequencies and detecting signals of interest are employed in numerous military and commercial applications. One approach to wideband signal detection employs a channelized receiver, with which a frequency spectrum of interest is partitioned or segregated into numerous channels, each having a bandwidth much narrower than the total frequency spectrum of interest. By observing outputs in the channels, signals occurring at different frequencies in the spectrum of interest can be detected.

One example of a channelized receiver used for signal detection, described in commonly assigned U.S. patent application Ser. No. 11/078,237, filed Mar. 11, 2005, titled “Channelized Receiver System With Architecture For Signal Detection And Discrimination,” which is incorporated herein by reference in its entirety, is depicted in FIG. 1. At a high level, receiver 100 includes a channelizer having a filter bank in which each filter possesses a passband spanning some portion of the frequency spectrum of interest. The passbands of all filters span the complete spectrum of interest. The filter bank disseminates received energy to a number of channels, and the energy in each channel is processed to detect which channels contain signals.

In channelized receiver 100, input energy is provided to channelizer 110, which includes multiple filters 110₁, 110₂ . . . 110n. Each filter in filter bank 110 has a different center frequency, with the filters being ordered in accordance with their center frequencies. The output of each filter represents the components of the input having frequencies falling in the pass band of that filter. The outputs of channelizer 110 are applied to a bank of comparators 130₁, 130₂ . . . 130n. Each comparator compares the energy in one of the channels to a threshold provided by threshold mask generation module 120, which may be adjusted such as with a linear offset provided by adders 125₁, 125₂ . . . 125n. The outputs of comparators 130₁, 130₂ . . . 130n are provided to decision logic 140, which processes the outputs to identify whether certain of the channels contains a signal that should be selected for further processing.

### SUMMARY OF INVENTION

According to one aspect of the present invention, a method comprises acts of: (A) providing a channelizer which receives a digital representation of an analog input signal and produces a plurality of digital output signals, each digital output signal representing a frequency band within a bandwidth of the analog input signal; (B) during at least one first time period, demodulating at least one digital output signal produced by the channelizer to extract communications data from the at least one digital output signal; and (C) during at least one second time period, processing at least one digital output signal produced by the channelizer for a purpose other than extracting communications data from the at least one digital output signal.

According to another aspect of the invention, a communications system comprises an analog-to-digital converter, a channelizer and at least one circuit. The analog-to-digital converter receives an analog input signal and produces a digital representation of the analog input signal. The channelizer receives the digital representation of the analog input signal and produces a plurality of digital output signals, each digital output signal representing a frequency band within a bandwidth of the analog input signal. The at least one circuit is configured to demodulate, during at least one first time period, at least one digital output signal produced by the channelizer to extract communications data from the at least one digital output signal, and to process, during at least one second time period, at least one digital output/signal produced by the channelizer for a purpose other than extracting communications data from the at least one digital output signal.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram depicting a conventional channelized receiver;

FIG. 2 is a block diagram of a channelized receiver and communications adapter embodying various aspects of the invention;

FIG. 3 is a block diagram depicting an exemplary architecture in which a channelized receiver and communications adapter such as that shown in FIG. 2 may be implemented; and

FIG. 4 is a block diagram depicting a communications system embodying various aspects of the invention.

### DETAILED DESCRIPTION

In some embodiments of the present invention, a communications system may be provided which expands and extends the capabilities of a channelized receiver, so that the communications system is not only capable of performing electronic surveillance monitoring (e.g., signal detection), but also is capable of performing as a communications adapter to, for example, relay information to one or more downstream devices (e.g., the onboard systems of a military vehicle or other mobile platform). For example, in some embodiments, a communications system may include and supplement a channelized receiver with one or more components adapted to process the channel output(s) of the channelized receiver (e.g., by demodulating the channel output(s) to extract communications data therefrom), and transmit the results of this processing to a communications interface module for delivery to one or more downstream devices. As such, a communications system implemented in accordance with some embodiments of the invention may be capable of performing both signal detection and communications relay functions, and may switch between the two functions as the user desires or circumstances dictate, or perform both functions at the same time.

Commonly assigned U.S. patent application Ser. No. 11/603,320, filed Nov. 21, 2006, entitled “Methods And Apparatus For Accessing Vehicle Electronics Systems,” the entirety of which is incorporated by reference, describes an interface module to which a communications system implemented in accordance with embodiments of the invention might provide output. This interface module is designed to, among other things, connect downstream devices to the Global Information Grid (GIG). The GIG is a system designed to enable information processing, storage, management, and transport for military and defense operations. In particular, the GIG enables information to be shared among geographically dispersed forces, increasing collaboration and situational awareness, and allowing for a greater degree of synchronization and effectiveness. Via the interface module, a military vehicle may become a node on the GIG, such that devices implemented on the vehicle may receive information from, and provide information to, other nodes on the GIG. For example, a helicopter's onboard systems may receive updated satellite images or intelligence on the location of a target during a mission, so that the helicopter's pilot need not rely solely on information loaded to the onboard devices prior to the mission or information received by onboard sensors or via a radio. As the mission proceeds, onboard systems may generate updated information, which may then be transmitted to one or more other nodes on the GIG.

Embodiments of the present invention may allow a mobile platform to function, for example, as a node on the GIG with minimal changes to the platform or its onboard systems. In this respect, we have appreciated that changes to a platform or its systems can jeopardize the platform's reliability and safety, and may mean that the platform must undergo a lengthy security or safety re-certification before being placed into service again. As embodiments of the invention extend the capabilities of channelized receivers commonly implemented on many platforms, communications receipt, transmission, and/or relay capability may be added with minimal changes to the platform or the devices, and thus minimal implementation and testing efforts. As such, other devices on the platform may be given the capability to receive information from, and transmit information to, other nodes on the GIG without extensive modifications.

Of course, embodiments of the invention need not be implemented to enable devices on a military vehicle to communicate with nodes on the GIG. For example, embodiments of the invention need not be implemented on a mobile platform, and need not be utilized to allow any particular type of device(s) to communicate via any particular communications infrastructure and/or protocol. In this respect, embodiments of the invention may be employed in any setting in which a system adapted to perform both signal detection and communications functions is useful, such as for commercial and/or civilian uses. The invention is not limited to being implemented in any particular setting.

Some embodiments of the invention may provide wideband (e.g., up to 512 MHz) or ultra-wideband (e.g., up to 2 GHz) communications capability. Wideband or ultra-wideband communications capability may be provided in any suitable manner, as the invention is not limited to any particular implementation. For example, in some embodiments, a combiner may be provided to receive and combine incoming signals to a wideband or ultra-wideband spectral space. By providing wideband or ultra-wideband communications capability, embodiments of the invention may increase the speed at which information can be provided to, for example, devices on a mobile platform. Further, providing a wider spectral space may allow incoming signals to be segregated into a greater number of channels. Consequently, information may be provided faster, to a greater number of devices.

In some embodiments, communications capability may be provided by one or more programmable components, so that the processing performed to extract communications data from incoming signals may be changed over time. Consequently, the system may be adapted to support any of numerous applications. For example, in some embodiments, a programmable demodulator is employed to process channel output(s) of a receiver to extract communications data therefrom. A programmable demodulator may be implemented in any of numerous ways, as the invention is not limited in this respect. For example, a programmable demodulator may be implemented via one or more field programmable gate arrays (FPGAs), application specific integrated circuits (ASICs), cell processors, programmed procedures executing on a Multi-Processor or Multi-Core PowerPC or other high performance processor(s), other components, or some combination of the foregoing. If the demodulator is programmable, it may be configured to demodulate signals employing any modulation technique, and may be adapted over time as new modulation techniques are introduced.

A demodulator may additionally or alternatively perform any of numerous types of logical processing on channel output(s) not associated with demodulation. In this respect, as used herein, the term “demodulator” is intended to be non-limiting and merely illustrative of the capabilities of the component(s) described.

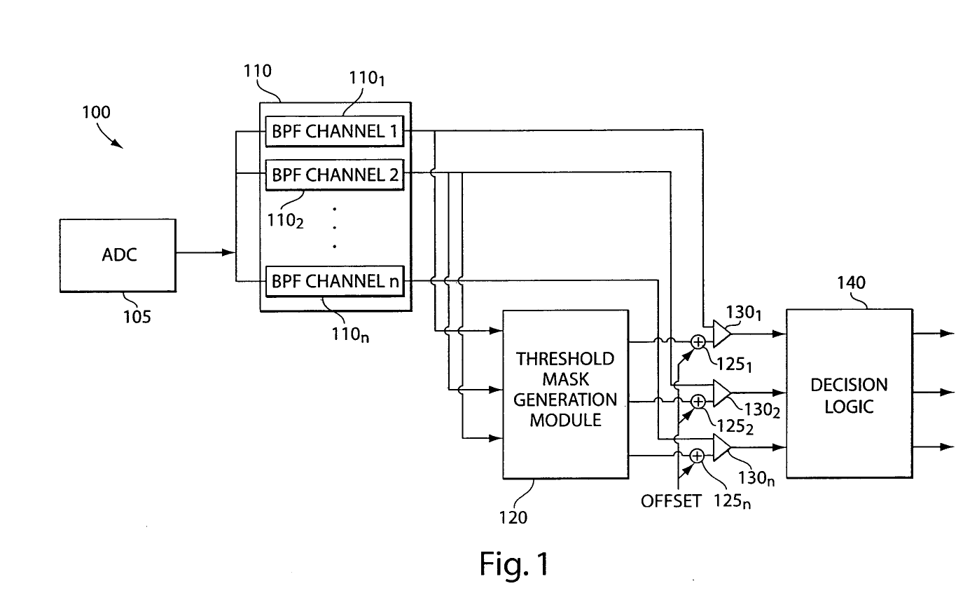

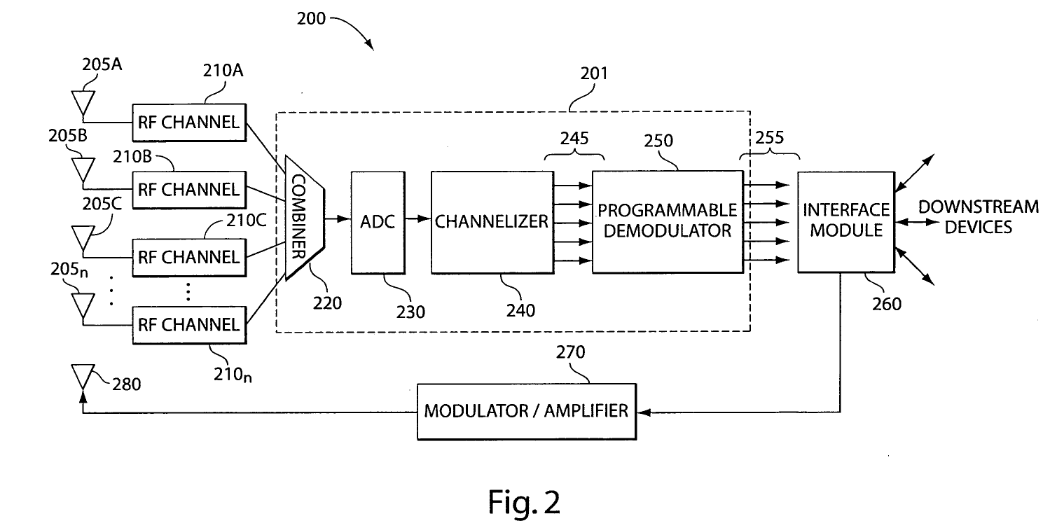

As shown in FIG. 2, system 200 may include components of the channelized receiver described above with reference to FIG. 1, in addition to other components that enable system 200 to function as a communications adapter. A receiver/adapter that may be implemented in connection with some embodiments of the invention is indicated with dotted lines 201.

In the example shown, receiver/adapter 201 includes combiner 220, which receives incoming radio frequency (RF) signals 210A-210n from antennae 205A-205n.

Combiner 220 combines these signals to a wideband or ultra-wideband spectral space, and provides output to analog-to-digital converter (ADC) 230. ADC 230 provides a digital representation of the combined signal to channelizer 240, which de-multiplexes that digital signal into one or more channel outputs 245. Programmable demodulator 250 processes the output(s) 245 to extract communications data, and provides one or more outputs 255 to interface module 260. Interface module 260 provides output(s) 255 to one or more downstream devices (e.g., onboard a military vehicle). Interface module 260 may also receive output from one or more downstream devices and provide it to modulator/amplifier 270, which prepares the output for transmission and provides it to transmission antenna 280. Each of these components is described in further detail below.

Combiner 220 may receive input signals provided in any suitable form and comprising any suitable information, as the invention is not limited to any particular implementation. For example, RF channel input 210A may comprise a radio signal, and RF channel inputs 210B-210C may comprise a wideband digital stream including a satellite image, intelligence information, programmed instructions, other information, or a combination thereof (e.g., received by one or more antennae installed on a military vehicle).

Although only four RF channel inputs 210A-210n are depicted in FIG. 2, any suitable number of inputs may be provided, each employing any suitable modulation scheme and/or communications protocol. Also, although FIG. 2 indicates that each channel input is provided in RF form, the invention is not limited to such an implementation, as any suitable form of electromagnetic energy may be received and processed. For example, any or all of channel inputs 210A-210n may comprise microwave, infrared, laser, other form of electromagnetic energy, or a combination thereof.

Combiner 220 may combine input provided by RF channel inputs 210A-210n to produce a composite output signal in any of various ways, and the invention is not limited to any particular combining technique. In some embodiments, for example, combiner 220 may perform frequency division multiplexing to create a composite signal from the RF channel inputs. In other embodiments, combiner 220 may additionally or alternatively perform time division multiplexing, wavelength division multiplexing, or any other manner of multiplexing or combining. The invention is not limited to any particular implementation.

Multiplexing multiple analog input signals (e.g., from RF channels 210A-210n) to produce a single composite signal may enable the output of combiner 220 to be processed more efficiently by downstream components (e.g., ADC 230) than if each analog input signal were processed individually by those downstream components.

Specifically, a single processing step may be performed on one composite signal, rather multiple processing steps being performed on multiple signals.

In some embodiments, combiner 220 generates a wideband signal output. For example, in some embodiments, combiner 220 may generate output having a bandwidth of, for example, 2 GHz. Of course, the invention is not limited to a signal of any particular bandwidth. Signal bandwidth may be chosen, for example, based on the application for which system 200 is employed.

Combiner 220 provides signal output to ADC 230, which converts the composite signal from analog to digital form. Conversion may be performed in any suitable manner, as the invention is not limited to any particular technique. In some embodiments, ADC 230 may generate a parallel bit stream representing the signal, although the invention is not limited to such an implementation. One or more serial bit streams may additionally or alternatively be provided.

ADC 230 provides digital output to channelizer 240, which de-multiplexes the output in the digital domain to produce, as an example, multiple channel outputs. Although described with reference to FIG. 1 as performing filtering according to frequency band, channelizer 240 may produce channelized output using any a priori knowledge, as the invention is not limited to any particular implementation. In some embodiments, channelizer 240 de-multiplexes the output of ADC 230 to separate it into different communication sets, such as voice data, video, data streams, other information, or a combination thereof.

If channelizer 240 is used to generate multiple channel outputs, each may span a any desired portion of the entire frequency spectrum of interest. For example, a 512 MHz frequency spectrum of interest may be divided into four 128 MHz channels, eight 64 MHz channels, five hundred twelve 1 MHz channels, or any other desired number of portions. Of course, each portion need not span the same percentage of the entire frequency spectrum of interest. For example, a 512 MHz frequency spectrum of interest might be divided into one 256 MHz channel and four 64 MHz channels. The number of channels and bandwidth of each channel may be chosen, for example, based on the application for which system 200 is employed.

The output of channelizer 220 is provided to programmable demodulator 250, which processes each channel output to extract any communications data provided therein, as is well-known to those skilled in the art. As described above, programmable demodulator may comprise any of numerous components adapted to process channel outputs produced by channelizer 240. For example, programmable demodulator 250 may comprise one or more field programmable gate arrays (FPGAs), application specific integrated circuits (ASICs), cell processors, programmed procedures executing on a Multi-Processor or Multi-Core PowerPC or other high performance processor(s), other component(s), or a combination thereof. The invention is not limited to any particular implementation, and those skilled in the art may envision numerous ways of implementing programmable demodulation capabilities.

In some embodiments, programmable demodulator 250 may be capable of applying different demodulation algorithms to different channel outputs of channelizer 240. For example, programmable demodulator 250 may apply a Quadrature Phase Shift Keying (QPSK) demodulation algorithm to a first channel output, a Frequency Shift Keying (FSK) demodulation algorithm to a second channel output, another demodulation algorithm to another channel output, and so on. Any demodulation algorithm may be applied to any channel output, as the invention is not limited in this respect.

It should be appreciated that embodiments of the invention are not limited to implementing demodulation algorithms corresponding to existing modulation schemes, as algorithms corresponding to later-developed modulation schemes may additionally or alternatively be employed. The invention is not limited in this respect.

In some embodiments, programmable demodulator 250 may be capable of applying a communication protocol to each output 255. For example, if an output 255 is to be transmitted by interface module 260 to a downstream device via a network which employs the Transmission Control Protocol/Internet Protocol (TCP/IP), then programmable demodulator 250 may apply this protocol to the output. A protocol may be applied in any suitable manner, and those skilled in the art may envision numerous techniques for doing so.

In some embodiments, programmable demodulator 250 may be capable of processing channel output generated by channelizer 240 to suit any number of applications. In one example, programmable demodulator 250 may execute one or more programmed procedures to compensate for Doppler frequency shift, which can occur when a signal is received on a mobile platform from a transmitter which is moving with respect to the mobile platform. For example, a signal received by a first airplane from a second airplane that is moving toward the first airplane at a supersonic speed may shift, for example, up to 4 MHz, and can cause a receiver on the first airplane tuned to a specific channel to lose the signal. Accordingly, in some embodiments, programmable demodulator 250 may process channel output of channelizer 240 to detect and/or compensate for Doppler frequency shift. For example, if a transmission received on a mobile platform at a particular frequency (e.g., in a particular channel output of channelizer 240) from another mobile platform is lost, programmable demodulator 250 may execute programmed logic to examine the output of channelizer 240 residing in one or more channels nearby the channel in which the signal had previously been received. If a signal is detected in one or more of the nearby channels, programmable demodulator 250 may compensate for the shift.

In examining channel output to determine whether Doppler frequency shift has occurred, programmable demodulator 250 may employ information provided by, for example, one or more system(s) on board a mobile platform. This information may indicate, for example, to what extent the frequency of the signal may have shifted. For example, it is known that there is a positive correlation between the extent of a Doppler frequency shift, the speed of the receiving platform, the speed of the transmitting platform, and the platforms' relative direction (e.g., whether they are headed toward each other). As a result, in some embodiments, programmable demodulator 250 may receive information from onboard systems as to the speed and direction of each platform, and employ it in processing channel output of channelizer 240 to compensate for Doppler frequency shift. For example, if the transmitting and receiving platforms are traveling toward each other at a supersonic speed, programmable demodulator 250 may examine a wider frequency range to detect and/or compensate for Doppler frequency shift than if the two platforms were moving away from each other at a subsonic speed.

Of course, compensating for Doppler frequency shift need not be performed using the exemplary techniques described above, and may be accomplished in any of numerous ways. Embodiments of the invention are not limited to any particular implementation. In addition, embodiments of the invention may additionally or alternatively perform one or more other types of logical processing that are unrelated to detecting and/or compensating for Doppler frequency shift, as the invention is not limited in this respect.

As described in above-referenced commonly assigned U.S. patent application Ser. No. 11/603,320, interface module 260 may implement a peer-to-peer architecture to provide information to one or more downstream devices. Of course, embodiments of the invention are not limited to being employed with an interface module which functions in this manner. The invention is not limited to any particular implementation.

As shown in FIG. 2, in some embodiments, system 200 may be capable of transmitting information (e.g., from any downstream device) via antenna 280. Specifically, interface module 260 may provide information to modulator/amplifier 270, which may prepare the information for transmission via antenna 280 by modulating the information (employing any suitable modulation scheme), converting it from digital to analog form, amplifying the analog signal, and providing the analog signal to antenna 280. Those skilled in the art will recognize that any of numerous techniques may be employed to prepare the information for transmission via antenna 280, and the invention is not limited to any particular technique. In some embodiments, the components employed in the modulator/amplifier 270 may simply provide inverse functionality to those in receiver/adapter 201.

It should be appreciated from the foregoing description that embodiments of the invention may extend and generalize the capabilities of a channelized receiver to provide a user-configurable communications adapter that may be employed for any of numerous applications. For example, in enabling broadband capability, embodiments of the invention may provide a broad spectral space into which any number of incoming signals, each carrying any form of information, may simultaneously be multiplexed. This spectral space may be channelized into any desired number of channel outputs, each comprising any desired portion of the entire frequency spectrum of interest. Programmable components may optionally be provided for extracting data from the channel output(s), such that each output may be processed in any desired manner, to suit any desired application.

As a result, embodiments of the invention may provide a flexible, scalable and extensible configuration which may be adapted to process any number and type of input signals, in any desired manner. Consequently, existing platform configurations may be easily modified and/or re-purposed. For example, a new antenna might be added to an existing platform to provide a new input signal, which may be processed in any desired fashion. An existing antenna currently employed for radar detection or surveillance might, for example, be re-purposed to look for another type of signal, and this new signal may be processed to suit any desired application. Those skilled in the art will envision numerous ways in which embodiments of the invention might be employed.

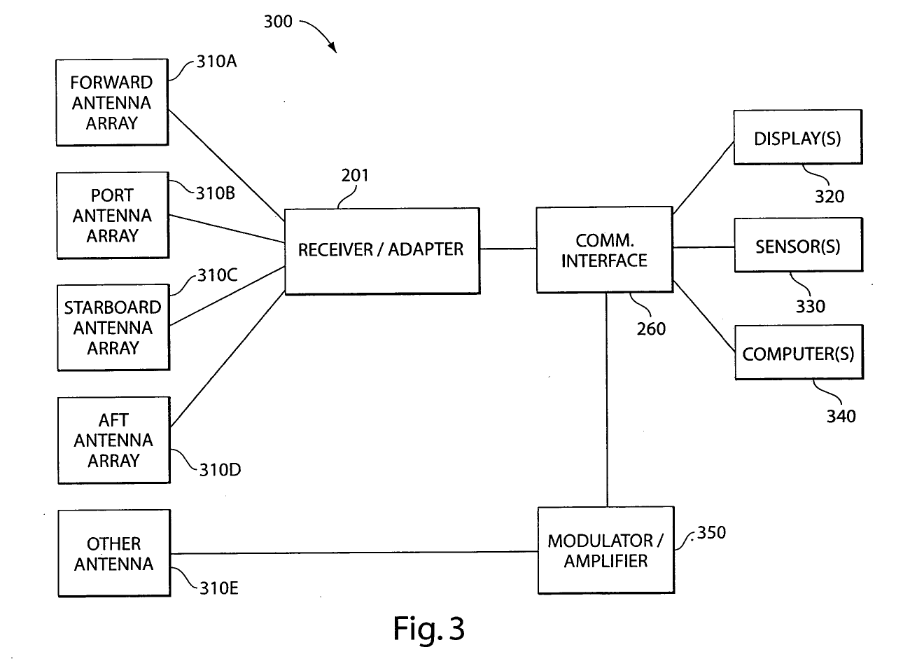

FIG. 3 depicts one example of an architecture in which certain embodiments of the invention may be employed. In particular, FIG. 3 depicts an architecture that may be deployed on a mobile platform, such as a military vehicle, in which receiver/adapter 201 (also depicted in FIG. 2) is employed to receive and process multiple input analog signals. In the example architecture depicted, receiver/adapter 210 receives input analog signals from forward, port, starboard and aft antenna arrays 310A-310D. As described above, receiver/adapter may combine the signals from antenna arrays 310A-310D to generate a wideband composite signal, convert the signal to digital form, channelize the output and apply demodulation algorithms to extract communications data therefrom. Demodulated output may be provided to interface module 260, which in turn may provide the information to the systems and/or devices implemented onboard the platform, (e.g., any or all of display(s) 320, sensor(s) 330 and computer(s) 340). As shown, interface module 260 may also receive information generated by any or all of display(s) 320, sensor(s) 330 and computer(s) 340, and provide this information to modulator/amplifier 350 for transmission via antenna 310E.

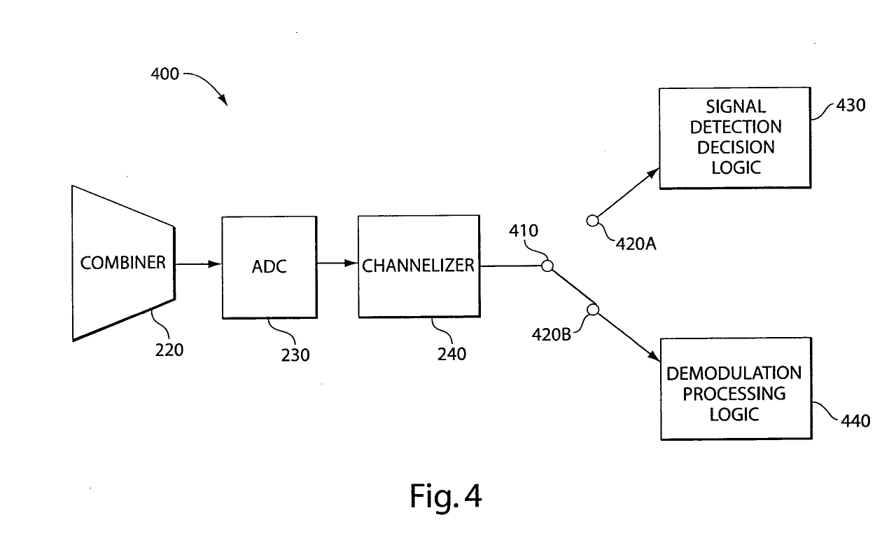

FIG. 4 is a simplified representation of a communications system adapted to perform as an electronic surveillance monitoring (ESM) receiver or a communications adapter. System 400 includes combiner 220, ADC 230 and channelizer 240, described above with reference to FIG. 2. System 400 also includes a switch which allows a connection to be made to either of terminals 420A or 420B. When a connection is made to terminal 420A, channelizer 240 provides channel output to signal detection decision logic 430. For example, channel output may be provided to threshold mask generation module 120 and decision logic 140 (described above with reference to FIG. 1). When a connection is made to terminal 420B, channel output is provided to demodulation processing logic 440. For example, channel output may be provided to programmable demodulator 250 (FIG. 2), which may extract communications data therefrom (e.g., for delivery to interface module 260).

It should be appreciated that the configuration shown in FIG. 4 is merely exemplary, and that any of numerous possible configurations may be employed to enable a communications system implemented in accordance with embodiments of the invention to perform as a receiver and/or a communications adapter. For example, some configurations may enable the system to perform as both a receiver and a communications adapter simultaneously. Some configurations may allow the system to perform each function during partially overlapping time periods (e.g., by allowing a user to select whether both or either of the functions are performed during a particular time period). Any configuration may be employed, to suit any of numerous applications, as the invention is not limited in this respect.

It should also be appreciated that, if the communications system is otherwise adapted to perform either signal detection or communications adapter functions at any one time, but not both simultaneously, a switch need not be employed to change between these functions. Those skilled in the art may envision numerous alternatives, and the invention is not limited to any particular implementation.

Further, it should be appreciated that the depiction in FIG. 4 of signal detection decision logic 430 and demodulation processing logic 440 as separate components is merely illustrative, and that the invention is not limited to being implemented in this fashion. For example, functionality provided by signal detection decision logic 430 and demodulation processing logic 440 may be provided by a single component which, for example, executes programmed procedures that perform either or both functions, and/or other functions. In this respect, signal detection decision logic 430 and demodulation processing logic 440 should be viewed as functional (and not necessarily physical) components which may be implemented in any suitable fashion.

Embodiments of the present invention can be implemented in any of numerous ways. For example, any of the functionality discussed above may be implemented using hardware, firmware, software or a combination thereof. When implemented via software, program code can be executed on any suitable processor or collection of processors, whether provided in a single computer or distributed among multiple computers. In addition, any component or collection of components that perform the functions described herein can be generically considered as one or more circuits. The one or more circuits may be implemented in numerous ways, such as with dedicated hardware or firmware, or by employing one or more processors that are programmed using microcode or software to perform the functions recited above.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method, comprising acts of:
(A) providing a channelizer which receives a digital representation of an analog input signal and produces a plurality of digital output signals, each digital output signal representing a frequency band within a bandwidth of the analog input signal;
(B) during at least one first time period, demodulating at least one digital output signal produced by the channelizer to extract communications data from the at least one digital output signal; and
(C) during at least one second time period, processing at least one digital output signal produced by the channelizer for a purpose other than extracting communications data from the at least one digital output signal.

2. The method of claim 1, wherein the step (C) comprises processing the at least one digital output signal to perform electronic surveillance monitoring during the at least one second time period.

3. The method of claim 1, further comprising an act of combining multiple analog input channels to obtain the analog input signal.

4. The method of claim 1, wherein the analog input signal has a bandwidth of at least 512 MHz.

5. The method of claim 1, wherein the analog input signal has a bandwidth of at least 1 GHz.

6. The method of claim 1, wherein the act (B) further comprises demodulating the at least one digital output signal to extract the communications data therefrom.

7. The method of claim 1, wherein the act (B) further comprises employing different algorithms to process at least two different ones of the plurality of digital output signals to extract communications data therefrom.

8. The method of claim 1, wherein the at least one first time period comprises at least two portions, and wherein the act (B) comprises:
employing a first algorithm to process the at least one digital output signal during one of the at least two portions of the at least one first time period; and
applying a second algorithm to process the at least one digital output signal during another of the at least two portions of the at least one first time period.

9. The method of claim 1, further comprising an act of, during the at least one first time period, providing the communications data to an interface module for delivery to at least one downstream device implemented on a mobile platform.

10. The method of claim 1, wherein the act (C) further comprises processing the at least one digital output signal to detect a Doppler frequency shift.

11. The method of claim 1, wherein the at least one first time period and the at least one second time period overlap at least partially.

12. The method of claim 1, wherein the at least one first time period and the at least one second time period do not overlap.

13. A communications system, comprising:
an analog-to-digital converter which receives an analog input signal and produces a digital representation of the analog input signal;
a channelizer which receives the digital representation of the analog input signal and produces a plurality of digital output signals, each digital output signal representing a frequency band within a bandwidth of the analog input signal; and
at least one circuit configured to demodulate, during at least one first time period, at least one digital output signal produced by the channelizer to extract communications data from the at least one digital output signal, and to process, during at least one second time period, at least one digital output signal produced by the channelizer for a purpose other than extracting communications data from the at least one digital output signal.

14. The communications system of claim 13, wherein the at least one circuit is configured to process, during the at least one second time period, the at least one digital output signal to perform electronic surveillance monitoring.

15. The communications system of claim 13, further comprising a combiner which combines a plurality of analog input channels to produce the analog input signal.

16. The communications system of claim 15, wherein the combiner is adapted to produce an analog input signal having a bandwidth of at least 512 MHz.

17. The communications system of claim 15, wherein the combiner is adapted to produce an analog input signal having a bandwidth of at least 1 GHz.

18. The communications system of claim 13, wherein the at least one circuit is further configured to employ, during the at least one first time period, different algorithms to process at least two different ones of the plurality of digital output signals to extract communications data therefrom.

19. The communications system of claim 13, further comprising an interface module which receives the communications data from the at least one circuit during the at least one first time period and provides the communications data to at least one downstream device implemented on a mobile platform.

20. The communications system of claim 13, wherein the at least one circuit is further configured to process, during the at least one first time period, at least one digital output signal to detect a Doppler frequency shift.

21. The communications system of claim 13, wherein the at least one first time period and the at least one second time period overlap at least partially.

22. The communications system of claim 13, wherein the at least one first time period and the at least one second time period do not overlap.
